(19) United States
(12) Patent Application Publication
(10) Pub. No.: US 2026/0095336 A1
(43) Pub. Date: Apr. 2, 2026

(54) INTEGRATED TRUST PLATFORM MODULES, DEVICE ATTESTATION, AND DEVICE MANAGEMENT FOR LIVE ZERO TRUST NETWORK ACCESS

(71) Applicant: JAMF Software, LLC, Minneapolis, MN (US)

(72) Inventor: Matt Vlasach, Larkspur, CA (US)

(21) Appl. No.: 19/343,748

(22) Filed: Sep. 29, 2025

Related U.S. Application Data
(60) Provisional application No. 63/701,291, filed on Sep. 30, 2024.

(51) Int. Cl. H04L 9/32; H04L 9/08

(52) U.S. Cl. CPC H04L 9/3268; H04L 9/0866; H04L 9/088

(57) ABSTRACT

Systems, apparatus, and methods for device attestation are disclosed. An example apparatus includes communication circuitry to obtain a request to access an organization resource and a client certificate including a device identifier and a certificate authority issuer, at least one memory storing machine readable instructions, and programmable circuitry to execute the machine readable instructions to determine that the certificate authority issuer is a trusted issuer, compare the device identifier against device identifiers in a database storing trusted device identifiers of an organization protecting the organization resource, in response to determining that an instance of the device identifier exists in the database, determine that a client device associated with the device identifier is authorized to access the organization resource based on checking a policy of the organization, and grant the client device access to the organization resource.

### RELATED APPLICATION

This patent arises from a U.S. Provisional Ser. No. 63/701,291 , which was filed on Sep. 30, 2024. U.S. Provisional Ser. No. 63/701,291 is hereby incorporated herein by reference in its entirety. Priority to U.S. Provisional Ser. No. 63/701,291 is hereby claimed.

### TECHNICAL FIELD

The present disclosure generally relates to platform security, and more specifically relates to integrated trusted platform modules, device attestation and device management for live zero trust network access verdicts.

### BACKGROUND

Organizations, businesses, networks, and the like are exposed to risks and threats as the landscape of malware expands. As networks and resources become more distributed and threats to data confidentiality become more aggressive, organizations have sought more secure ways to ensure that only authorized users on authorized devices have access to sensitive resources. Such a security solution that an organization may implement is a zero trust security model. Zero trust is a security framework in which user access requests for data or resources on an organization's network always need to be authenticated and authorized. Zero trust is being used due to the dissolving network boundary of most organizations. Identity is a new network perimeter, and verification of digital identities on an organization's network is central to a zero trust strategy. However, many organizations mistakenly assume that limiting verification to user identities is sufficient.

The description provided in the background section should not be assumed to be prior art merely because it is mentioned in or associated with the background section. The background section may include information that describes one or more aspects of the subject technology.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for device attestation in a Zero Trust Network Access system.

FIG. 2 is a block diagram illustrating an example first implementation of the architecture of FIG. 1.

FIG. 3 is an example second implementation of the architecture of FIG. 1 to illustrate a data and communication process for device attestation in a Zero Trust Network Access system.

FIG. 4 is a flowchart representative of machine readable instructions which may be executed to implement the example edge connectivity circuitry of FIG. 3 to perform device attestation.

FIG. 5 is a block diagram illustrating an example computer system structured to execute instructions, including the instructions of FIG. 4, to implement the example architecture of FIGS. 1, 2, and 3.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

True zero trust implementation relies upon certificates and key pairs to strengthen security and ensure device verification in addition to identity verification. Such certificates include X.509 certificates, which are digital documents issued by a certificate authority (CA) that verify the identity of organizations, individuals, and websites through use of a public key. To provide some background on X.509 certificates, X.509 certificates use a public key infrastructure (PKI) framework to provide authentication. The process begins with the creation of a public-private key pair. The entity that requested the certificates then generates a certificate signing request (CSR) that contains the entity's public key and identifying data. The CSR is then sent to a CA that checks the digital signature against the CA's known public key. During this step, a chain of intermediate certificates leads back to a trusted root CA contained inside a trust store. Once the CA successfully validates the identifying information in the public key, the CA signs with its private key, issuing an X.509 certificate.

Currently, there is an inherent trust problem when using traditional X.509 certificates. Systems and organizations that use X.509 certificates may automatically trust actors within the process chain. For example, while ideally an actor is a customer administrator or a privileged vendor administrator, there may be an external attacker/hacker who acts as an actor that could, with an elevated authorization level and malintent, deploy a certificate to a device in their control, purporting to be another known user's or device's identity. For example, a certificate could be deployed, purporting to be that of the CEO or CISO, authorizing access to services as that user in systems that trust such certificate-based authentication methods. In another example, a purported identifier of a device (e.g., device ID such as a serial number) could be spoofed to that of a known and privileged device. The spoofed device identifier tricks the device management system into providing advanced access capabilities, deploying sensitive resources, or offering reduced logging and visibility.

To overcome problems in zero trust architectures, different authentication methods have been developed, such as OpenID Connect (OIDC) and Security Assertion Markup Language (SAML). These methods do not leverage certificates, but, instead, require multi-factor authentication (MFA) to access resources. Similar to zero trust systems, a user must identify themselves using multiple factors. In some examples, one of the factors is “something you have” in the form of a Fast IDentity Online (FIDO) USB key or other device (e.g. mobile phone). Beyond authenticating the user by using these factors, there lacks a step for authenticating the device the user is authenticating from. Existing methods do not truly assess that the device is, or should be, trusted with otherwise valid user-centric MFA credentials. While there are some tools that make it harder to log in on an unauthorized device, ultimately the device management or trust plane is usually established through a user-based credential as well, ultimately establishing device-trust as a surrogate of the user's identity instead of remaining truly mutually exclusive.

Examples disclosed herein provide a solution to overcome current device attestation methods in a zero trust architecture. For example, the disclosed technology advantageously provides a platform security feature that ensures genuine, untampered client devices can interact with an organization's mobile device management (MDM) and IT infrastructure by using hardware-based cryptographic verification. As used herein, hardware-based cryptographic verification is defined as a security method where specialized hardware of a device is used to perform cryptographic operations and securely store sensitive data, like encryption keys. Hardware-based cryptographic verification provides a higher level of security and performance compared to software-based methods by isolating the cryptographic process from a main operating system and central processing unit (CPU) of the device, making the device more resistant to tampering and malware. Examples disclosed herein eliminate any entity in the system from defining the identity of the device in a non-cryptographic way. For example, a device self-claims its identifier and an attestation service (e.g., Apple Attestation Service) attests to that claim using a hardware-based subsystem within a processor of the device that creates a trusted execution environment (TEE). In examples disclosed herein, the identifier is communicated throughout the zero trust system from that point forward by using an X.509 certificate that is issued by the MDM provider after validating the attestation of the attestation service (e.g., Apple Attestation Service). The disclosed technology provides improvements over traditional approaches by using attested attributes of the device. Accordingly, the disclosed system provides a just-in-time device record that is linked and validated persistently against the MDM using cryptographically attested device metadata, which is an improvement over existing methods.

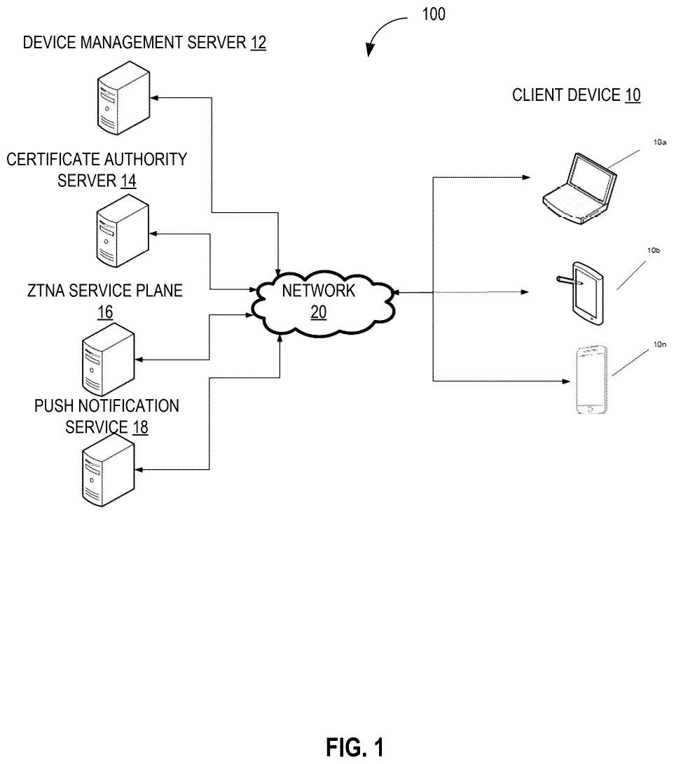

FIG. 1 illustrates an example architecture 100 for device attestation in a Zero Trust Network Access system. The architecture 100 includes an example client device 10, such as an example first client device 10a, an example second client device 10b, and an example N^{th} client device 10n, an example device management server 12, an example certificate authority (CA) server 14, an example Zero Trust Network Access (ZTNA) service plane 16, an example push notification service 18, and an example network 20.

In FIG. 1, the example client devices 10, the example device management server 12, the example CA server 14, the example ZTNA service plane 16, and the example push notification service 18 are communicatively connected via the example network 20. In some examples, the device management server 12 may be connected to the push notification service 18 over a separate network.

In FIG. 1, the client device 10 is a managed device managed by the device management server 12. For example, the first client device 10a and the second client device 10b may be managed (e.g., controlled, updated, secured, etc.) by the device management server 12. In some examples, the client device 10 can be a tablet computer, a mobile phone, a mobile computer, a laptop computer, a portable media player, an electronic book (eBook) reader, or any other device having appropriate processor, memory, and communications capabilities.

In FIG. 1, the device management server 12 is a service used by an organization to monitor, manage, and secure client devices 10 that are used by their employees, whether the devices are company-owned or personally owned. In some examples, the device management server 12 enables IT administrators to enforce security policies, deploy software and settings remotely, track devices for loss or theft, and ensure data protection, ultimately reducing security risks and improving productivity in a mobile or hybrid work environment. In some examples, the device management server 12 can be implemented by any device having an appropriate processor, memory, and communications capability for communicating with the at least one client device 10, the certificate authority server 14, the ZTNA service plane 16, and the push notification service 18. For purposes of load balancing, the device management server 12 may include multiple servers.

In FIG. 1, the certificate authority server 14 is a service that enables an organization to deploy, manage, and secure their own private certificate authorities (CAs). A CA is a trusted entity that verifies the identity of individuals, devices, or websites and issues digital certificates to establish trust and secure online communications, like HTTPS connections. A CA server 14 automates and simplifies this process, allowing businesses to issue their own certificates for internal use (e.g., for VPNs, IoT devices) or for broader public-facing applications. In some examples, the CA server 14 can be implemented by any device having an appropriate processor, memory, and communications capability for communicating with, at least, the at least one client device 10, the device management server 12, and the ZTNA service plane 16. In some examples, the CA server 14 may be implemented by a cloud-based server.

In FIG. 1, the ZTNA service plane 16 is a service that implements the zero trust security model by verifying users and granting access to specific resources based on identity and context policies. As described above, the zero trust security model assumes that threats are present both inside and outside a network and therefore requires strict verification for every user and device before authorizing a user and/or device to access internal resources. In some examples, the ZTNA service plane 16 can be implemented by any device having an appropriate processor, memory, and communications capability for communicating with, at least, the at least one client device 10, the device management server 12, the certificate authority server 14, and the push notification service 18.

In FIG. 1, the push notification service 18 can be implemented by any device having an appropriate processor, memory, and communications capability for communicating with the device management server 12 and the at least one client device 10.

In some examples, the device management server 12, the certificate authority server 14, the ZTNA service plane 16, and a push notification service 18 may be implemented in a cloud computing server of an infrastructure-as-a-service (IaaS) and be able to support a platform-as-a-service (PaaS) and software-as-a-service (SaaS) services.

In FIG. 1, the network 20 can include, for example, any one or more of a personal area network (PAN), a local area network (LAN), a campus area network (CAN), a metropolitan area network (MAN), a wide area network (WAN), a broadband network (BBN), the Internet, and the like. Further, the network 20 can include, but is not limited to, any one or more of the following network topologies, including a bus network, a star network, a ring network, a mesh network, a star-bus network, tree or hierarchical network, and the like.

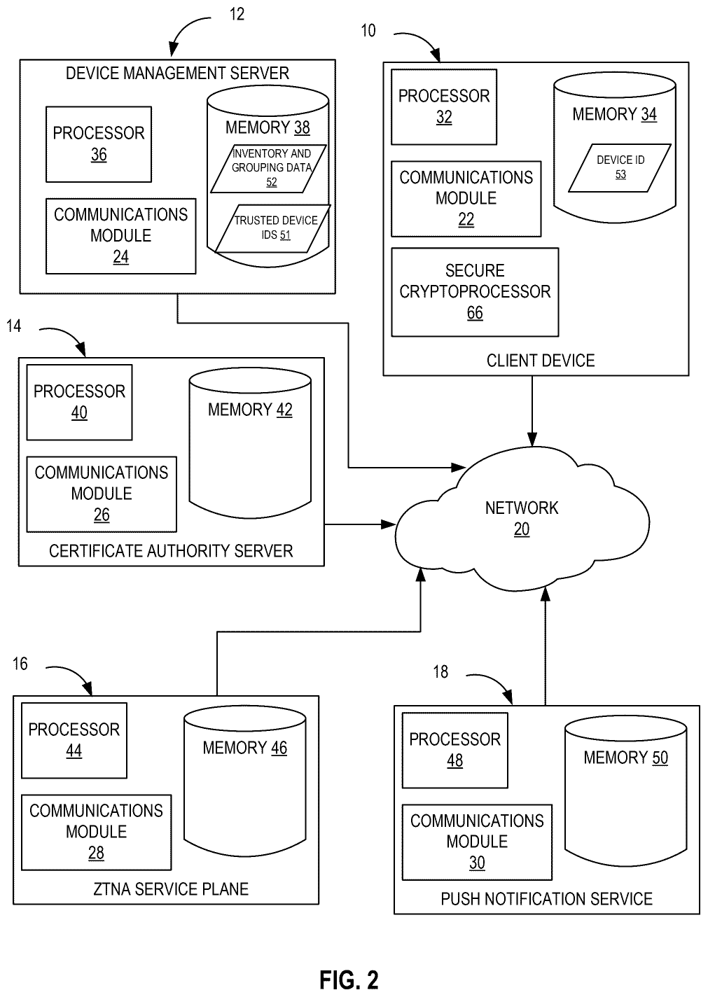

FIG. 2 is a block diagram illustrating an example implementation of the client device 10, the device management server 12, the certificate authority server 14, the ZTNA service plane 16, and the push notification service 18 of FIG. 1. It should be understood that for purposes of explanation, one client device 10 is illustrated, but any number of the client devices 10a, 10b, 10n may be illustrated.

In FIG. 2, the client device 10, the device management server 12, the certificate authority server 14, the ZTNA service plane 16, and the push notification service 18 are connected over the network 20 via respective communication modules 22, 24, 26, 28, 30.

The communication modules 22, 24, 26, 28, 30 are configured to interface with the network 20 to send and receive information, such as data, requests, responses, and commands to other devices on the network 20. In some examples, the communication modules 22, 24, 26, 28, 30 may be referred to as communication circuitry. For example, the communication module 28 may be interface circuitry to send and receive data from the client device 10. In some examples, the communication modules 22, 24, 26, 28, 30 are modems. Additionally, and/or alternatively, communication modules 22, 24, 26, 28, 30 are Ethernet cards.

The client device 10 includes a processor 32, the communications module 22, a memory 34, and a secure cryptographic processor 66. The memory 34 stores at least one device identifier (ID) 53. In some examples, the device ID 53 is a serial number of assigned to the client device 10, a unique device identifier (e.g., UDID) assigned to the client device 10, etc. The processor 32 of the at least one client device 10 is configured to execute instructions, such as instructions physically coded into the processor 32, instructions received from software in memory 34, or a combination of both. In some examples, the secure cryptographic processor 66 is a dedicated processing chip that performs cryptographic processing. The secure cryptographic processor 66 is isolated from the processor 32, such that data processed by the secure cryptographic processor 66, such as cryptographic keys and secure user data, is not accessible by the processor 32. In some examples, the secure cryptographic processor 66 creates the trusted execution environment (TEE). In examples disclosed herein, the TEE is an isolated processing environment in which applications can be securely executed irrespective of the rest of the client device 10. For example, the TEE implements an attestation service that enables the client device 10 to cryptographically prove its authenticity and integrity to a remote server or management system (e.g., device management server 12). The secure cryptographic processor 66 enables examples disclosed herein to perform hardware-based cryptographic verification, which improves device attestation.

The device management server 12 includes a processor 36, the communications module 24, and a memory 38. The memory 38 is a database that stores example inventory and grouping data 52 and trusted device identifiers 51. The processor 36 of the device management server 12 is configured to execute instructions, such as instructions physically coded into the processor 36, instructions received from software in the memory 38, or a combination of both.

The device management server 12 may correspond to hardware and/or software that implement mobile device management functions. For example, the device management server 12 may manage the client device 10. As such, the device management server 12 stores (or accesses) inventory and grouping data 52 associated with the client device 10. The inventory and grouping data 52 may include enrollee data identifying all mobile devices that are managed by the device management server 12, as well as data (e.g., configured task window settings) associated with the client device 10 and grouping information of managed devices within the same designated group.

The certificate authority server 14 includes a processor 40, the communications module 26, and a memory 42. The processor 40 of the certificate authority server 14 is configured to execute instructions, such as instructions physically coded into the processor 40, instructions received from software in the memory 42, or a combination of both.

The ZTNA service plane 16 includes a processor 44, the communications module 28, and a memory 46. The processor 44 of the ZTNA service plane 16 is configured to execute instructions, such as instructions physically coded into the processor 44, instructions received from software in the memory 46, or a combination of both.

The push notification service 18 includes a processor 48, the communications module 30, and a memory 50. The processor 48 of the push notification service 18 is configured to execute instructions, such as instructions physically coded into the processor 48, instructions received from software in the memory 50, or a combination of both.

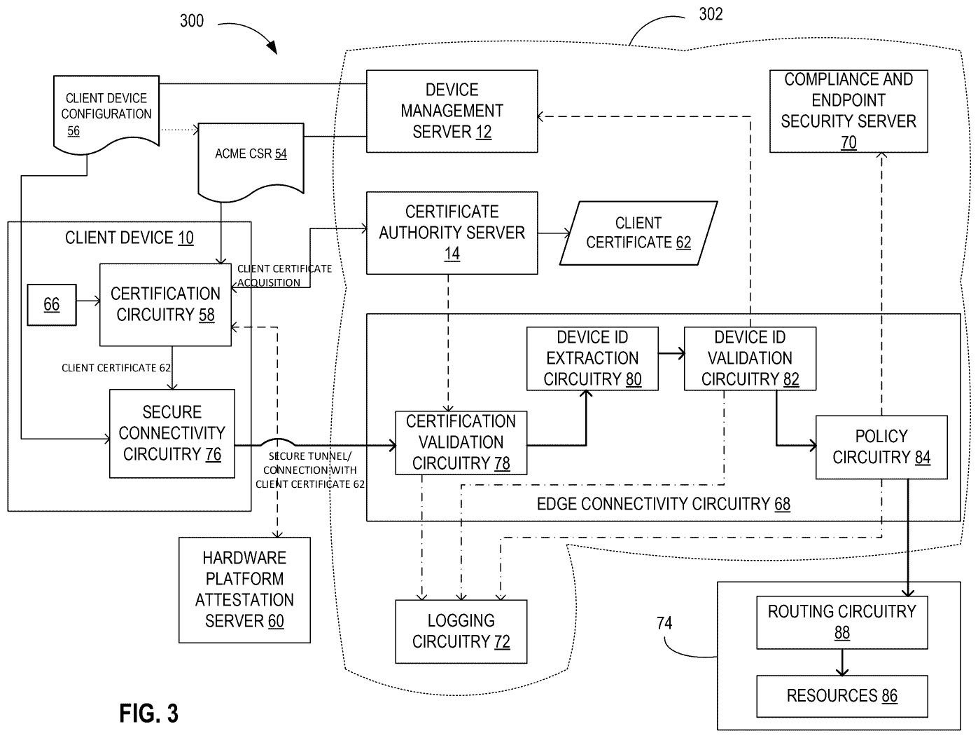

FIG. 3 illustrates an example architecture implementation 300 of the architecture 100 of FIG. 1 to show a data and communication process for device attestation in a Zero Trust Network Access system. The example process for device attestation in a Zero Trust Network Access system will now be described with reference to the example architecture implementation 300 (e.g., implementation 300) of FIG. 3. The implementation 300 of FIG. 3 includes the example client device 10 of FIG. 1, the example device management server 12 of FIG. 1, the example certificate authority (CA) server 14 of FIG. 1, an example hardware platform attestation server 60, example edge connectivity circuitry 68, an example compliance and endpoint security server 70, example logging circuitry 72, and an example customer server 74.

In FIG. 3, the client device 10 includes example certification circuitry 58 and example secure connectivity circuitry 76. The certification circuitry 58 requests and receives device ID attestation certificates from the hardware platform attestation server 60. As used herein, a device ID attestation certificate is a digital certificate including at least one device identifier that the manufacturer of the client device 10 has certified belongs to the client device 10. In some examples, the certification circuitry 58 requests a device ID attestation certificate from the hardware platform attestation server 60 using a private, non-exportable, hardware-bound key (e.g., “key”) generated by and/or provided by the secure cryptographic processor 66, described above in connection with FIG. 2. In some examples, the key generated or stored by the secure cryptographic processor 66 is used by the hardware platform attestation server 60 to retrieve a certified device identifier for the client device 10.

In FIG. 3, the secure connectivity circuitry 76 enables the client device 10 to securely connect with resources (e.g., resources 86) of the customer server 74. For example, the secure connectivity circuitry 76 may be instantiated by a processor executing instructions to create an encrypted tunnel between the client device 10 and the customer server 74 to route data.

In FIG. 3, the edge connectivity circuitry 68 implements the Zero Trust Network Access (ZTNA) service plane 16 of FIGS. 1 and 2. In some examples, the edge connectivity circuitry 68 is instantiated by an edge server executing instructions to verify and authenticate the client device 10. Alternatively, the edge connectivity circuitry 68 is instantiated by a cloud server executing instructions to verify and authenticate the client device 10. In FIG. 3, the edge connectivity circuitry 68 includes example certification validation circuitry 78, example device identifier (ID) extraction circuitry 80, example device identifier (ID) validation circuitry 82, and example policy circuitry 84.

In FIG. 3, the certification validation circuitry 78 validates an issuer of a client certificate. As used herein, a client certificate is an X.509 certificate that includes the device identifiers that were provided by the manufacturer of the client device 10 in the device ID attestation certificate. For example, the certification validation circuitry 78 checks a real-time status service to confirm a certificate authority issuer, such as the CA server 14, who issued the client certificate is still trusted. Specifically, the certification validation circuitry 78 checks a list of denylisted or untrustworthy certificate authority issuers to identify whether the CA server 14 is a trusted issuer. The certification validation circuitry 78 does not establish any form of authentication or authorization that may be used to allow the client device 10 to obtain access to the resource 86. Instead, the certification validation circuitry 78 verifies, at an early point in the device authentication process with no implicit trust, the identity of the requesting client device 10.

In FIG. 3, the device ID extraction circuitry 80 extracts the device ID from the client certificate. For example, the device ID extraction circuitry 80 obtains the client certificate and extracts a universal device ID (UDID), a secure enclave enrollment ID (SEEID), and/or any other identifier issued by the hardware platform attestation server 60.

In FIG. 3, the device ID validation circuitry 82 validates the device ID. For example, the device ID validation circuitry 82 compares the device ID against a database of device IDs in the device management server 12. In some examples, the memory 38 (FIG. 2) of the device management server 12 stores instances of valid device IDs, provided by the manufacturer of the client device 10. In such an example, the device ID validation circuitry 82 validates the device ID when the database of the device management server 12 stores a matching device ID.

In FIG. 3, the policy circuitry 84 and the compliance and endpoint security server 70 work together to provide insight into what resource(s) the client device 10 is authorized to access, based on the device ID. For example, the policy circuitry 84 identifies a request for access to a resource, submitted by the client device 10, and determines whether the client device 10 is authorized to access that resource based on information from the compliance and endpoint security server 70. In some examples, the compliance and endpoint security server 70 provides encrypted and conditional access to resources (e.g., corporate resources, entity resources, etc.) by verifying users and devices. In some examples, the policy circuitry 84 is instantiated to check the compliance and endpoint server 70 for authorized accesses when the client certificate issuer has been validated and when the device ID has been validated. Otherwise, the policy circuitry 84 does not need to check the device ID of the client device 10 against associated policies.

In FIG. 3, the logging circuitry 72 stores return responses from the certification validation circuitry 78, the device ID validation circuitry 82, and/or the policy circuitry 84.

For example, the logging circuitry 72 logs “unauthorized” responses when any one of the certification validation circuitry 78, the device ID validation circuitry 82, and/or the policy circuitry 84 return an “unauthorized” response. For example, if the certification validation circuitry 78 determines that the CA server 14 has been revoked, the certification validation circuitry 78 unauthorizes the client certification issuer and notifies the logging circuitry 72 to log the unauthorized CA issuer. In some examples, the logging circuitry 72 logs “success” responses returned from the policy circuitry 84 when the policy circuitry 84 identifies a successful and authorized access to resources 86.

In FIG. 3, the customer server 74 is a server owned and operated by a business entity, a corporation, or any other entity that manages client devices, including client device 10, issued to users. In some examples, the customer server 74 provides resources 86 to users (e.g., employees, family members, etc.) such as applications, workloads, and other various services. In some examples, the resources 86 may include private, sensitive, or personal data that only authorized users and authorized client devices can access. In some examples, the customer server 74 is implemented by an on-premises server, a cloud server, a hybrid server, an Infrastructure-as-a-Service (IaaS) server, etc.

In FIG. 3, the customer server 74 includes the routing circuitry 88 to route a request from the client device 10 to appropriate at least one appropriate resource 86. For example, the routing circuitry 88 is instantiated by programmable circuitry executing instructions to manage and secure all incoming traffic and selecting the path to send and receive data packets between the client device 10 and the at least one resource 86. In some examples, the routing circuitry 88 routes malware-free traffic from the client device 10 to resources of the customer server 74.

In FIG. 3, the device management server 12, the certificate authority server 14, the edge connectivity circuitry 68, the compliance and endpoint security server 70, and the logging circuitry 72 are virtualized and hosted remotely by an example management and security cloud 302. The management and security cloud 302 is a cloud network provisioned by an organization (e.g., such as the organization who operates and runs the customer server 74) to manage and secure client devices 10. In some examples, the management and security cloud 302 is the JAMF® cloud.

An example data and communication process of the implementation 300 is now described. The device management server 12 enrolls the client device 10 as a managed device for access to resources 86 in the customer server 74. In some examples, the device management server 12 uses enrollment processes such as, but not limited to, Apple Device Enrollment (ADE), Account Driven Device Enrollment (ADDE), Account Driven User Enrollment (ADUE), etc.

As part of the enrollment process, a user of the client device 10 is properly authenticated. Additionally, as a part of the enrollment process, the device management server 12 validates a device ID assigned to the client device 10. In some examples, the device ID is device ID 53 (FIG. 2) which may represent a unique device identifier (UDID), a serial number, a Secure Enclave Enrollment ID (SEEID), or any other device ID. In some examples, the device management server 12 validates the device ID as a trusted device in the customer's device management system through pre-loading of approved device identifiers or specific allowances based upon enrollment type (e.g., bring-your-own-devices (BYOD)). In some examples, the device management server 12 un-enrolls the client device 10 is the client device 10 is an untrusted device. Alternatively, the device management server 12 marks an client device 10 as untrusted and providing the client device 10 limited access downstream (e.g., limited access to resources 86), such as in the case of BYOD.

When the client device 10 is enrolled, the device management server 12 issues the client device 10 an Automatic Certificate Management Environment (ACME) Certificate Signing Request (CSR) 54 and a client device configuration 56. As used herein, an ACME CSR is a request generated by an ACME client of the device management server 12 that contains a public key for a domain of the customer, a private key signature, and a domain name. The ACME CSR 54 is generic, such that there are no claimed device identifiers in the payload. The ACME CSR 54 also does not require pre-shared secrets to request a certificate from the CA server 14 using the ACME CSR. As such, every client device receives the same ACME CSR 54 payload. As used herein, the client device configuration information 56 is information used by the secure connectivity circuitry 76 to establish a secure network connection to the customer server 74. In some examples, the client device configuration information includes a Virtual Private Network (VPN) configuration, a Zero Trust Network Access (ZTNA) configuration, a proxy configuration information, or relay configuration information.

The generic ACME CSR 54 means that any genuine client device with a functional and supported TEE (created by the secure cryptographic processor 66) can acquire a valid client certificate using the ACME CSR 54. However, unlike a traditional public key infrastructure (PKI) framework, the present disclosure does not care who obtains a client certificate. Instead, it is the attributes in that client certificate that matter and are used for access validation as part of this disclosure. Therefore, although any client device can acquire a valid client certificate, not every client device will be able to acquire a client certificate that contains necessary device identifiers that have been explicitly and cryptographically validated and attested to by the edge connectivity circuitry 68.

Returning to the example data and communication flow, responsive to receiving the ACME CSR 54, the client device 10 acquires an attestation certificate from an attestation server 60. For example, the certification circuitry 58 obtains the ACME CSR 54 from the device management server 12 and requests a device identifier (ID) attestation certificate from the hardware platform attestation server 60. The returned device ID attestation certificate includes at least one device identifier 53 (e.g., UDID, Serial Number, SEEID) that the hardware platform attestation server 60 has certified belongs to the client device 10 that is making the request. Then, using ACME CSR 54, the client device 10 connects to the certificate authority server 14 and presents the device ID attestation certificate that was returned from the attestation server 60. The certificate authority server 14 then challenges the client device 10 to answer a question that can be answered if the client device 10 owns the private key. In some examples, the CA server 14 uses a WebAuthn-based process involving a nonce built into the protocol of the ACME CSR 54 to challenge the client device 10 with a question.

Based on the certificate authority server 14 receiving a successful answer, the certificate authority server 14 returns a client certificate 62. For example, the CA server 14 returns an X.509 certificate that includes the device identifier 53 (e.g., UDID, serial number, SEEID) provided by the hardware platform attestation server 60 in the device ID attestation certificate. Thus far, various certificate authority and certificate chain checks were performed along the way to make sure only trusted entities were used throughout the process.

The client device 10 then uses the device ID attestation certificate with the client device configuration information 56 to connect to a resource of the resources 86. For example, the secure connectivity circuitry 76 provides a valid device ID attestation certificate and correct network relay information (e.g., protocol information to establish an encrypted tunnel) to the edge connectivity circuitry 68. The edge connectivity circuitry 68 facilitates the secure connection between the client device 10 and the resources 86. When connecting to a resource that is protected by a proxy (e.g., a Network Relay, a VPN, etc.), the client device 10 will create a new connection via processes such as, but not limited to, Multiplexed Application Substrate over QUIC Encryption (MASQUE) connection to a MASQUE edge proxy (e.g., the edge connectivity circuitry 68), VPN, cert-based authorities, etc., and attach the device ID attestation certificate as its client identity.

While attaching the device ID attestation certificate is not unusual for VPN or other networking processes (e.g., mTLS), the way this device ID attestation certificate is analyzed and used for authentication and authorization downstream is germane to the present disclosure and will be described in more detail below.

In conventional systems, the zero trust network access infrastructure validates that a) the certificate was issued by a trusted certification authority service and b) the certificate has not been revoked. In these conventional systems, if both checks pass, then all of the attributes in the certificate are inherently trusted. For example, the device ID, user ID, or other identifiers or claims in the certificate are not further checked. Accordingly, in such conventional systems, such as in legacy PKI, a major security gap exists in a Zero Trust Architecture.

In the disclosed device attestation approach, the edge connectivity circuitry 68 closes the aforementioned gap. Based upon the client device configuration information 56 (e.g., MASQUE tunneling, VPN, etc.), which includes a logical binding to the customer's ZTNA service plane 16, the edge connectivity circuitry 68 (e.g., the MASQUE edge proxy) associated with the ZTNA service plane 16 can facilitate further verification of the client device 10. The data and communication process therefore continues when the certification validation circuitry 78 cryptographically validates that the device ID attestation certificate is from a trusted certificate authority. For example, the certification validation circuitry 78 verifies the certificate authority server 14 (not the device ID attestation certificate) has not been revoked. In doing so, verification at this point has been made with high assurance and zero implicit trust of the identity of the client device 10. At this point, no form of authentication or authorization of the client device 10 has been established yet (e.g., the client device 10 is not yet allowed to get access to any resources 86).

Next, the device ID extraction circuitry 80 extracts the device ID 53 (e.g., UDID, serial number, SEEID) associated with the client device 10 from the device ID attestation certificate (e.g., cryptographically verified).

Once the device ID 53 is obtained, the device ID validation circuitry 82 validates that this identifier 53 exists in the customer's device management server 12. If the device ID validation circuitry 82 determines that the identifier 53 exists in the database of the device management server 12, then the device ID validation circuitry 82 authenticates the client device 10. For example, the device ID validation circuitry 82 authenticates the client device 10 to the organization's tenant. Accordingly, a just-in-time device record is created in the ZTNA service plane 16 that is linked persistently to the device management server 12 via a programmatic service-to-service integration. A just-in-time device record refers to a temporary record created for a device (e.g., the client device 10) only when the record is needed, rather than being pre-created and always available. The just-in-time device record reduces a risk of outdated information corresponding to the device. Alternatively, the client device 10 may be pre-provisioned in the ZTNA service plane 16 as well as the device management server 12 such that just-in-time provisioning is not necessary.

After the device ID validation circuitry 82 authenticates the client device 10, the policy circuitry 84 determines whether the at client device 10 is authorized to access a given resource or not. For example, the policy circuitry 84 polls the compliance and endpoint security server 70 to determine whether the device ID associated with the client device 10 is in compliance with the requirements to access the desired resource. If the policy circuitry 84 determines that the client device 10 is authorized to access the resource, the policy circuitry 84 notifies the routing circuitry 88. The routing circuitry 88 then routes access to the resource per software-defined networking rules. If the policy circuitry 84 determines that the client device 10 is not authorized to access the resource, the policy circuitry 84 and the routing circuitry 88 devices a connection to the resource. The data and communication flow of this implementation 300 ends when the client device 10 is granted access to at least one of the resources 86. In some examples, the data and communication flow of this implementation 300 may be repeated when a different client device 10 requests access to one or more of the resources 86.

Over time, the client device 10 may become unenrolled from the organization (e.g., the customer). When this happens, the client device 10 is marked as deleted from the device management server 12. While most device management servers 12 should remove the device ID attestation certificate credential with the client device configuration 56 from the client device 10 when this happens, it is not inconceivable that a malicious device may still retain these configurations and attempt to use the device ID attestation certificate and the client device configuration 56 to access sensitive resources 86. However, once the device ID attestation certificate is presented to the edge connectivity circuitry 68 (e.g., the MASQUE edge proxy, etc.) associated with the ZTNA security plane service 16, the device ID attestation certificate will fail the live authentication check because the presented device ID is no longer present in the database of the device management server 12. In other words, the client certificate 62 is still valid, however, the client certificate 62 is no longer authenticated and therefore not authorized to access any of the resources 86.

While an example manner of implementing the edge connectivity circuitry 68 is illustrated in FIG. 3, one or more of the elements, processes and/or devices illustrated in FIG. 3 may be combined, divided, re-arranged, omitted, eliminated and/or implemented in any other way. Further, the example certification validation circuitry 78, the example device ID extraction circuitry 80, the example device ID validation circuitry 82, the example policy circuitry 84, and/or, more generally, the example edge connectivity circuitry 68 of FIG. 3 may be implemented by hardware, software, firmware and/or any combination of hardware, software and/or firmware. Thus, for example, any of the example certification validation circuitry 78, the example device ID extraction circuitry 80, the example device ID validation circuitry 82, the example policy circuitry 84, and/or, more generally, the example edge connectivity circuitry 84 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example certification validation circuitry 78, the example device ID extraction circuitry 80, the example device ID validation circuitry 82, and/or the example policy circuitry 84 is/are hereby expressly defined to include a non-transitory computer readable storage device or storage disk such as a memory, a digital versatile disk (DVD), a compact disk (CD), a Blu-ray disk, etc. including the software and/or firmware. Further still, the example edge connectivity circuitry 68 of FIG. 3 may include one or more elements, processes and/or devices in addition to, or instead of, those illustrated in FIG. 3, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

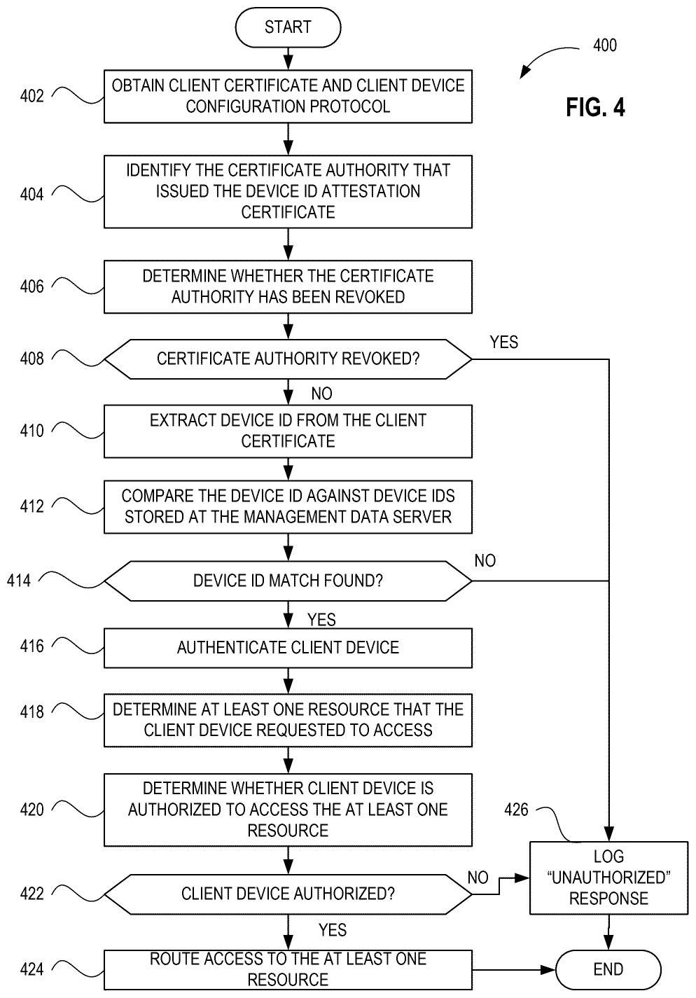

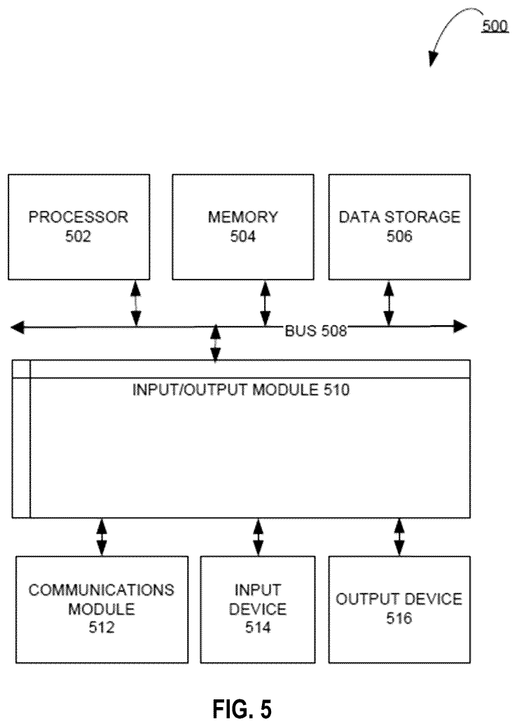

A flowchart representative of example hardware logic, machine readable instructions, hardware implemented state machines, and/or any combination thereof for implementing the edge connectivity circuitry of FIG. 3 is shown in FIG. 4. The machine readable instructions may be one or more executable programs or portion(s) of an executable program for execution by a computer processor and/or processor circuitry, such as the processor 502 shown in the example computer system 500 discussed below in connection with FIG. 5. The program may be embodied in software stored on a non-transitory computer or machine readable storage medium such as a CD-ROM, a floppy disk, a hard drive, a DVD, a Blu-ray disk, or a memory associated with the processor 502, but the entire program and/or parts thereof could alternatively be executed by a device other than the processor 502 and/or embodied in firmware or dedicated hardware. Further, although the example program is described with reference to the flowchart illustrated in FIG. 4, many other methods of implementing the example edge connectivity circuitry 68 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

FIG. 4 illustrates an example client device validation and authentication operation 400 of the example edge connectivity circuitry 68 of FIG. 3 to validate and authenticate a client certificate provided to the client device. The operation 400 begins at block 402 at which the edge connectivity circuitry 68 obtains a client certificate 62 (FIG. 3) and a client device configuration protocol 56 (FIG. 3) from a client device 10 (FIG. 3). For example, when connecting to a resource that should be protected by a secure connection, the secure connectivity circuitry 76 (FIG. 3) creates a new application layer tunneling protocol connection (e.g., a MASQUE connection, a VPN connection, etc.) to the edge connectivity circuitry 68, attaching the client certificate 62 (e.g., an ACME certificate), acquired by the secure connectivity circuitry 76, as the client identity of the client device 10.

At block 404, the edge connectivity circuitry 68 identifies the certificate authority that issued the client certificate 62. For example, the client certificate includes attributes in the payload, including the domain of the CA issuer, the device ID certified by the hardware platform attestation server 60 (FIG. 3), and other information.

At block 406, the edge connectivity circuitry 68 determines whether the certificate authority has been revoked. For example, the certification validation circuitry 78 (FIG. 3) checks a list or a real-time status service to confirm the CA server 14 (FIG. 3) that issued the client certificate is still trusted and has not been denylisted or deemed untrustworthy. In some examples, the certification validation circuitry 78 stores the list. Alternatively, the certification validation circuitry 78 uses an application programming interface (API) to call on a service that stores updated lists of verified CA servers.

At block 408, when the edge connectivity circuitry 68 determines that the certificate authority has not been revoked (e.g., block 408 returns a value NO), the operation proceeds to block 410 where the edge connectivity circuitry 68 extracts the device ID from the client certificate. For example, the device ID extraction circuitry 80 (FIG. 3) identifies, among the attributes in the client certificate 62, the device ID provided and certified by the hardware platform attestation server 60.

At block 412, the edge connectivity circuitry 68 compares the device ID against device IDs stored at the management data server 12 (FIG. 3). For example, the device ID validation circuitry 82 (FIG. 3) validates that the device identifier exists in the as an instance in the memory 38 (FIG. 2) of the device management server 12.

At block 414, the edge connectivity circuitry 68 determines whether a device ID match has been found. For example, if the device ID validation circuitry 82 identifies a match between the extracted device ID and the device ID in the device management server 12, then block 414 returns a value YES and the operation 400 proceeds to block 416.

At block 416, the edge connectivity circuitry 68 authenticates the client device 10. For example, the device ID validation circuitry 82 generates an “authenticated” or “authorized” tag or certificate to be associated with the client device 10 and the device ID. In some examples, the device ID validation circuitry 82 returns the “authenticated” certificate to the logging circuitry 72 (FIG. 3) to be logged.

At block 418, the edge connectivity circuitry 68 determines at least one resource that the client device 10 requested to access. For example, the policy circuitry 84 (FIG. 3) uses the client device configuration information 56 to identify one or more resources that the client device 10 is trying to access through the secure connection. In some examples, the resource may be an application, a service, data, a workload, etc.

At block 420, the edge connectivity circuitry 68 determines whether the client device 10 is authorized to access the at least one resource. For example, the policy circuitry 84 checks a compliance and endpoint security server 70 to determine whether the client device 10 is in compliance with standards required for the resource, whether the client device 10 satisfies a security level to access the resource, etc.

At block 422, when the edge connectivity circuitry 68 determines that the client device 10 is authorized (e.g., block 422 returns a value YES), control turns to block 424 at which the customer server 74 (FIG. 3) routes access to the at least one resource. For example, the policy circuitry 84 notifies the routing circuitry 88 (FIG. 3) that the client device 10 is authorized and authenticated and can access the resource of the resources 86 (FIG. 3). The routing circuitry 88 then routes access to the resource and the operation 400 ends.

Returning to block 408, if the edge connectivity circuitry 68 determines that the certificate authority has been revoked (e.g., block 408 returns a value “YES”), then control turns to block 426 where the logging circuitry 72 logs an “unauthorized” response. For example, the certification validation circuitry 78 notifies the logging circuitry 72 of the revoked CA and the logging circuitry 72 makes a record of the invalid CA. The operation 400 ends when the “unauthorized” response has been returned and no further authentication steps are taken.

Returning to block 414, if the edge connectivity circuitry 68 determines that a device ID match was not found (e.g., block 414 returns a value NO), then control turns to block 426 where the logging circuitry 72 logs an “unauthorized” response. For example, the device ID validation circuitry 82 notifies the logging circuitry 72 of the un-attested to device identifier, and the logging circuitry 72 makes a record of the un-attested to device identifier. The operation 400 ends when the “unauthorized” response has been returned and no further policy check steps are taken.

Returning to block 422, if the edge connectivity circuitry 68 determines that the client device 10 is not authorized (e.g., block 422 returns a value NO), then control turns to block 426 where the logging circuitry 72 logs an “unauthorized” response. For example, the policy circuitry 84 notifies the logging circuitry 72 of the non-compliant client device 10 with respect to the requested resource, and the logging circuitry 72 makes a record of the client device 10 and the unauthorized access to the requested resource. The operation 400 ends when the “unauthorized” response has been returned.

FIG. 5 is a block diagram illustrating an example computer system 500 with which the client device 10, the device management server 12, the certificate authority server 14, the ZTNA service plane 16, the push notification service 18, the hardware platform attestation server 60, the edge connectivity circuitry 68, the logging circuitry 72, the compliance and endpoint security server 70, and/or the customer server 74 of FIGS. 2 and 3 can be implemented. In certain aspects, the computer system 500 may be implemented using hardware or a combination of software and hardware, either in a dedicated server, or integrated into another entity, or distributed across multiple entities.

Computer system 500 includes a bus 508 or other communication mechanism for communicating information, and a processor 502 (e.g., the processor 32, 36, 40, 44, 48, and/or 66) coupled with bus 508 for processing information. According to one aspect, the computer system 500 can be a cloud computing server of an IaaS that is able to support PaaS and SaaS services.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., the memory 34, 38, 42, 46, and/or 50), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The machine readable instructions may be stored in the memory 504 and implemented in one or more computer program products, e.g., one or more modules of computer program instructions encoded on a computer readable medium for execution by, or to control the operation of, the computer system 500.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions.

Computer system 500 may be coupled via input/output module 510 to various devices. The input/output module 510 can be any input/output module. Example input/output modules 510 include data ports such as USB ports. In addition, input/output module 510 may be provided in communication with processor 502, so as to enable near area communication of computer system 500 with other devices. The input/output module 510 may provide, for example, for wired communication in some implementations, or for wireless communication in other implementations, and multiple interfaces may also be used. The input/output module 510 is configured to connect to a communications module 512. Example communications modules 512 (e.g., the communications module 22, 24, 26, 28, and/or 30) include networking interface cards, such as Ethernet cards and modems.

In certain aspects, the input/output module 510 is configured to connect to a plurality of devices, such as an input device 514 and/or an output device 516. Example input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device.

According to one aspect of the present disclosure the client device 10, the device management server 12, the certificate authority server 14, the ZTNA service plane 16, the push notification service 18, the hardware platform attestation server 60, the edge connectivity circuitry 68, the compliance and endpoint security server 70, the logging circuitry 72, and/or the customer server 74 can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. Processor 502 may process the executable instructions and/or data structures by remotely accessing the computer program product, for example by downloading the executable instructions and/or data structures from a remote server through communications module 512 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects a user of systems and methods as disclosed herein may perform at least some of the steps by accessing a cloud server through a network connection. Further, data files, circuit diagrams, performance specifications and the like resulting from the disclosure may be stored in a database server in the cloud-computing environment, or may be downloaded to a private storage device from the cloud-computing environment.

The term “machine-readable storage medium” or “computer-readable medium” as used herein refers to any medium or media that participates in providing instructions or data to processor 502 for execution. The term “storage medium” as used herein refers to any non-transitory media that store data and/or instructions that cause a machine to operate in a specific fashion. Such a medium may take many forms, including, but not limited to, non-volatile media, volatile media, and transmission media.

As mentioned above, the example operation of FIG. 4 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used in this specification of this application, the terms “computer-readable storage medium”, “machine readable medium”, and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that comprise bus 508. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in either one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Phrases such as an example, an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more. ” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular examples, but other examples can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

Example methods, apparatus, systems, and articles of manufacture to optimize thread scheduling are disclosed herein. Further examples and combinations thereof include the following:

Example 1 includes an apparatus comprising communication circuitry to obtain a request to access an organization resource and a client certificate including a device identifier and a certificate authority issuer; at least one memory storing machine readable instructions; and programmable circuitry to execute the machine readable instructions to: determine that the certificate authority issuer is a trusted issuer; compare the device identifier against device identifiers in a database storing trusted device identifiers of an organization protecting the organization resource; in response to determining that an instance of the device identifier exists in the database, determine that a client device associated with the device identifier is authorized to access the organization resource based on checking a policy of the organization; and grant the client device access to the organization resource.

Example 2 includes the apparatus of example 1, wherein the programmable circuitry is to: determine that the client device associated with the device identifier is not authorized to access the organization resourced based on checking the policy of the organization; and deny the client device access to the organization resource.

Example 3 includes the apparatus of example 1, wherein the device identifier is provided by a manufacturer of the client device.

Example 4 includes the apparatus of example 1, wherein the client certificate is issued by the certificate authority issuer in response to receiving a device identifier attestation certificate.

Example 5 includes the apparatus of example 4, wherein the client device is to obtain the device identifier attestation certificate sending a private, non-exportable, hardware-bound key generated by a secure cryptographic processor to a hardware platform attestation server, wherein the private, non-exportable, hardware-bound key is used by the hardware platform attestation server to retrieve a certified device identifier for the client device.

Example 6 includes the apparatus of example 1, wherein the programmable circuitry is to determine that the certificate authority issuer is the trusted issuer based on checking a list of denylisted certificate authority issuers.

Example 7 includes the apparatus of example 1, wherein the programmable circuitry is to return a response indicative that the client device is unauthorized when the (i) certificate authority issuer is not a trusted issuer, (ii) when the device identifier does not exist in the database storing trusted device identifiers, or (iii) when the client device associated with the device identifier is not authorized to access the organization resource.

Example 8 includes a non-transitory machine readable storage medium comprising instructions that, when executed by at least one processor, cause the at least one processor to obtain a request to access an organization resource and a client certificate including a device identifier and a certificate authority issuer; determine that the certificate authority issuer is a trusted issuer; compare the device identifier against device identifiers in a database storing trusted device identifiers of an organization protecting the organization resource; in response to determining that an instance of the device identifier exists in the database, determine that a client device associated with the device identifier is authorized to access the organization resource based on checking a policy of the organization; and grant the client device access to the organization resource.

Example 9 includes the non-transitory machine readable storage medium of example 8, wherein the instructions, when executed, cause one or more of the at least one processor to determine that the client device associated with the device identifier is not authorized to access the organization resourced based on checking the policy of the organization; and deny the client device access to the organization resource.

Example 10 includes the non-transitory machine readable storage medium of example 8, wherein the device identifier is provided by a manufacturer of the client device.

Example 11 includes the non-transitory machine readable storage medium of example 8, wherein the client certificate is issued by the certificate authority issuer in response to receiving a device identifier attestation certificate.

Example 12 includes the non-transitory machine readable storage medium of example 11, wherein the client device is to obtain the device identifier attestation certificate sending a private, non-exportable, hardware-bound key generated by a secure cryptographic processor to a hardware platform attestation server, wherein the private, non-exportable, hardware-bound key is used by the hardware platform attestation server to retrieve a certified device identifier for the client device.

Example 13 includes the non-transitory machine readable storage medium of example 8, wherein the instructions are to cause one or more of the at least one processor to determine that the certificate authority issuer is the trusted issuer based on checking a list of denylisted certificate authority issuers.

Example 14 includes the non-transitory machine readable storage medium of claim 8, wherein the instructions are to cause one or more of the at least one processor to return a response indicative that the client device is unauthorized when the (i) certificate authority issuer is not a trusted issuer, (ii) when the device identifier does not exist in the database storing trusted device identifiers, or (iii) when the client device associated with the device identifier is not authorized to access the organization resource.

Example 15 includes a computer-implemented method comprising obtaining a request to access an organization resource and a client certificate including a device identifier and a certificate authority issuer; determining that the certificate authority issuer is a trusted issuer; comparing the device identifier against device identifiers in a database storing trusted device identifiers of an organization protecting the organization resource; in response to determining that an instance of the device identifier exists in the database, determining that a client device associated with the device identifier is authorized to access the organization resource based on checking a policy of the organization; and granting the client device access to the organization resource.

Example 16 includes the computer-implemented method of example 15, further including determining that the client device associated with the device identifier is not authorized to access the organization resourced based on checking the policy of the organization; and denying the client device access to the organization resource.

Example 17 includes the computer-implemented method of example 15, wherein the device identifier is provided by a manufacturer of the client device.

Example 18 includes the computer-implemented method of example 15, wherein the client certificate is issued by the certificate authority issuer in response to receiving a device identifier attestation certificate.

Example 19 includes the computer-implemented method of example 18, wherein the client device is to obtain the device identifier attestation certificate sending a private, non-exportable, hardware-bound key generated by a secure cryptographic processor to a hardware platform attestation server, wherein the private, non-exportable, hardware-bound key is used by the hardware platform attestation server to retrieve a certified device identifier for the client device.

Example 20 includes the computer-implemented method of example 15, further including determining that the certificate authority issuer is the trusted issuer based on checking a list of denylisted certificate authority issuers.

Example 21 includes the computer-implemented method of example 15, further including returning a response indicative that the client device is unauthorized when the (i) certificate authority issuer is not a trusted issuer, (ii) when the device identifier does not exist in the database storing trusted device identifiers, or (iii) when the client device associated with the device identifier is not authorized to access the organization resource.

From the foregoing, it will be appreciated that example methods, apparatus and articles of manufacture have been disclosed that solve the technical problem of organization resources being comprised even in a zero trust architecture system by authenticating the attributes of client certificates, including client device identifiers. The disclosed methods, apparatus and articles of manufacture improve the functioning and usage of device management servers and device management computers. The disclosed methods, apparatus and articles of manufacture are accordingly directed to one or more improvement(s) in the functioning of a computer.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An apparatus comprising:
communication circuitry to obtain a request to access an organization resource and a client certificate including a device identifier and a certificate authority issuer;
at least one memory storing machine readable instructions; and
programmable circuitry to execute the machine readable instructions to:
determine that the certificate authority issuer is a trusted issuer;
compare the device identifier against device identifiers in a database storing trusted device identifiers of an organization protecting the organization resource;
in response to determining that an instance of the device identifier exists in the database, determine that a client device associated with the device identifier is authorized to access the organization resource based on checking a policy of the organization; and
grant the client device access to the organization resource.

2. The apparatus of claim 1, wherein the programmable circuitry is to:
determine that the client device associated with the device identifier is not authorized to access the organization resourced based on checking the policy of the organization; and
deny the client device access to the organization resource.

3. The apparatus of claim 1, wherein the device identifier is provided by a manufacturer of the client device.

4. The apparatus of claim 1, wherein the client certificate is issued by the certificate authority issuer in response to receiving a device identifier attestation certificate.

5. The apparatus of claim 4, wherein the client device is to obtain the device identifier attestation certificate sending a private, non-exportable, hardware-bound key generated by a secure cryptographic processor to a hardware platform attestation server, wherein the private, non-exportable, hardware-bound key is used by the hardware platform attestation server to retrieve a certified device identifier for the client device.

6. The apparatus of claim 1, wherein the programmable circuitry is to determine that the certificate authority issuer is the trusted issuer based on checking a list of denylisted certificate authority issuers.

7. The apparatus of claim 1, wherein the programmable circuitry is to return a response indicative that the client device is unauthorized when the (i) certificate authority issuer is not a trusted issuer, (ii) when the device identifier does not exist in the database storing trusted device identifiers, or (iii) when the client device associated with the device identifier is not authorized to access the organization resource.

8. A non-transitory machine readable storage medium comprising machine readable instructions that, when executed by at least one processor, cause the at least one processor to:
obtain a request to access an organization resource and a client certificate including a device identifier and a certificate authority issuer;
determine that the certificate authority issuer is a trusted issuer;
compare the device identifier against device identifiers in a database storing trusted device identifiers of an organization protecting the organization resource;
in response to determining that an instance of the device identifier exists in the database, determine that a client device associated with the device identifier is authorized to access the organization resource based on checking a policy of the organization; and
grant the client device access to the organization resource.

9. The non-transitory machine readable storage medium of claim 8, wherein the instructions are to cause one or more of the at least one processor to:
determine that the client device associated with the device identifier is not authorized to access the organization resourced based on checking the policy of the organization; and
deny the client device access to the organization resource.

10. The non-transitory machine readable storage medium of claim 8, wherein the device identifier is provided by a manufacturer of the client device.

11. The non-transitory machine readable storage medium of claim 8, wherein the client certificate is issued by the certificate authority issuer in response to receiving a device identifier attestation certificate.

12. The non-transitory machine readable storage medium of claim 11, wherein the client device is to obtain the device identifier attestation certificate sending a private, non-exportable, hardware-bound key generated by a secure cryptographic processor to a hardware platform attestation server, wherein the private, non-exportable, hardware-bound key is used by the hardware platform attestation server to retrieve a certified device identifier for the client device.

13. The non-transitory machine readable storage medium of claim 8, wherein the instructions are to cause one or more of the at least one processor to determine that the certificate authority issuer is the trusted issuer based on checking a list of denylisted certificate authority issuers.

14. The non-transitory machine readable storage medium of claim 8, wherein the instructions are to cause one or more of the at least one processor to return a response indicative that the client device is unauthorized when the (i) certificate authority issuer is not a trusted issuer, (ii) when the device identifier does not exist in the database storing trusted device identifiers, or (iii) when the client device associated with the device identifier is not authorized to access the organization resource.

15. A computer-implemented method comprising:
obtaining a request to access an organization resource and a client certificate including a device identifier and a certificate authority issuer;
determining that the certificate authority issuer is a trusted issuer;
comparing the device identifier against device identifiers in a database storing trusted device identifiers of an organization protecting the organization resource;
in response to determining that an instance of the device identifier exists in the database, determining that a client device associated with the device identifier is authorized to access the organization resource based on checking a policy of the organization; and
granting the client device access to the organization resource.

16. The computer-implemented method of claim 15, further including:
determining that the client device associated with the device identifier is not authorized to access the organization resourced based on checking the policy of the organization; and
denying the client device access to the organization resource.

17. The computer-implemented method of claim 15, wherein the device identifier is provided by a manufacturer of the client device.

18. The computer-implemented method of claim 15, wherein the client certificate is issued by the certificate authority issuer in response to receiving a device identifier attestation certificate.

19. The computer-implemented method of claim 18, wherein the client device is to obtain the device identifier attestation certificate sending a private, non-exportable, hardware-bound key generated by a secure cryptographic processor to a hardware platform attestation server, wherein the private, non-exportable, hardware-bound key is used by the hardware platform attestation server to retrieve a certified device identifier for the client device.

20. The computer-implemented method of claim 15, further including determining that the certificate authority issuer is the trusted issuer based on checking a list of denylisted certificate authority issuers.
